(19) United States
(12) Patent Application Publication
(10) Pub. No.: US 2004/0023824 A1
(43) Pub. Date: Feb. 5, 2004

(54) Use of nanoscale particles for improving dirt removal

(76) Inventors: Lars Züechner, Duesseldorf (DE); Ilona Lange, Langenfeld (DE); Horst-Dieter Speckmann, Langenfeld (DE); Josef Penninger, Hilden (DE)

Correspondence Address: HENKEL CORPORATION, THE TRIAD, SUITE 200, 2200 RENAISSANCE BLVD., GULPH MILLS, PA, 19406, US

(21) Appl. No.: 10/275,506

(22) PCT Filed: Apr. 27, 2001
(86) PCT No.: PCT/EP01/04781

(30) Foreign Application Priority Data
May 4, 2000 (DE) 100 21 726.5

(51) Int. Cl. C11D 7/02

(52) U.S. Cl. 510/276; 510/507; 510/508

(57) ABSTRACT

The invention relates to the use of particles with a particle size of 5 to 500 nm for improving the removal of dirt from and/or reducing the re-soiling of surfaces. Said particles can be used for finishing textiles, in textiles detergents and for pre-treating or post-treating textiles in particular.

This invention relates to the use of particles with a particle size of 5 to 500 nm for improving the removal of soil from surfaces and/or for reducing the resoilability of surfaces.

In the processing of textiles, refinement and particularly finishing are important factors. With the aid of appropriate auxiliaries, the properties of the textiles are modified in such a way that they are easier to care for. Examples of finishing measures include the improvement of crease recovery and dimensional stability, bleaching and treatment with optical brighteners or dyeing, the application of softening finishes to modify feel and hydrophilicization to increase water absorption capacity. In order to prevent the deposition of soil or to make it easier to remove by washing, the textiles contain a so-called soil release finish (soil-repellent finish).

Besides this permanent finishing of textiles, some of the described auxiliaries are also used inter alia in laundry detergents or in pretreatment or aftertreatment compositions in order to achieve temporary application. For example, corresponding soil release polymers are added to the detergents with a view to reducing resoiling by redeposition of the soil removed during the wash cycle itself.

Observations in the natural world have revealed that surfaces of plants have soil-repelling properties because soil particles are unable to settle permanently on those surfaces. Such surfaces are capable of cleaning themselves under the effect of rain or moving water. This effect is attributed to the layers of wax on the surface and particularly to their surface structure.

European Patent EP 0 772 514 describes a self-cleaning surface of objects—reproducing that of plants—which has an artificial surface structure of projections and depressions and which is characterized in that the distance between the projections is between 5 and 200 μm and the height of the projections is between 5 and 100 μm and in that the projections at least consist of hydrophobic polymers and durably hydrophobized materials so that the projections cannot be removed by water or by water containing detergents.

The textiles known from the prior art have a permanently modified surface. The permanent modification of textile surfaces is not always desirable, particularly in the field of clothing. On the one hand, consumers want natural textiles with the positive properties attributed to such textiles, on the other hand these textiles are expected to have the easy-care advantages of synthetics.

The problem addressed by the present invention was to provide a washing, pretreatment or aftertreatment composition which would be suitable for modifying, above all temporarily modifying, surfaces in such a way that an improvement in soil removal would be achieved and soil-release properties would be temporarily imparted to the surface. Another problem addressed by the invention was to achieve the desired improvement in particular for textile surfaces, preferably for natural materials, such as cotton.

It has surprisingly been found that, through the use of particles with a particle size of 5 to 500 nm on surfaces, i.e. both hard and textile surfaces, a distinct increase in hydrophilicity is achieved so that the removal of soil from the surfaces is also improved and soil-release properties can also be temporarily imparted to them. The use of the particles results in structuring of the surface so that the effects described above occur, for example, in textiles, particularly cotton or cotton/wool blends.

Temporary surface modification in the context of the present invention means that the effect can be maintained after a few, more particularly up to four, washing or cleaning cycles.

Accordingly, the present invention relates to the use of particles with a particle size of 5 to 500 nm for improving the removal of soil from surfaces and/or for reducing the resoilability of surfaces.

The particles used in accordance with the invention are preferably water-insoluble or poorly water-soluble particles which remain on the textile temporarily. According to the invention, these particles have a particle size of 5 to 500 nm and preferably in the range from 5 to 250 nm. In view of their particle size, these particles are also known as nanoscale particles. Any insoluble solids with particle sizes in the ranges mentioned may be used as the particles. Examples of suitable particles are any precipitated silicas, aerogels, xerogels, Mg(OH)₂, boehmite (Al(O)OH), ZrO₂, ZnO, CeO₂, Fe₂O₃, Fe₃O₄, TiN, hydroxylapatite, bentonite, hectorite, SiO₂:CeO₂ (CeO₂-doped SiO₂), SnO₂, In₂O₃:SnO₂, MgAl₂O₄, HfO₂, sols, such as SiO₂ sols, Al₂O₃ sols or TiO₂ sols and mixtures of the above.

Surfaces in the context of the present invention are any hard and textile surfaces to be treated. Hard surfaces are, in particular, surfaces encountered in the home, i.e. surfaces of stone, ceramics, wood, plastics, metals, such as stainless steel, incl. floor coverings, such as carpets, etc. Textile surfaces include any synthetic and natural textiles, the particles used in accordance with the invention preferably being used for the treatment of cotton and cotton/wool blends.

In a particularly preferred embodiment of the present invention, the particles are used in compositions for the treatment of textiles, more particularly for the pretreatment and aftertreatment of textiles and for the washing of textiles. The particles may also be used for textile treatment in the textile industry, in which case they may be used both for the permanent and for the temporary treatment of textiles.

The content of these nanoscale particles in such compositions should be gauged in such a way that the surface, particularly the textile surface, is sufficiently covered. The compositions preferably contain 0.01 to 35% by weight, more preferably 0.01 to 20% by weight and most preferably 0.5 to 10% by weight of the nanoscale particles, based on the final composition.

The concentration of the nanoscale particles used in accordance with the invention in the in-use solution is preferably between 0.001 and 10% by weight and more particularly between 0.01 and 2% by weight, based on the in-use solution. The pH value of the in-use solution is preferably between 6 and 12 and more particularly between 7 and 10.5. Particularly good results in regard to resoiling and soil removal are obtained in that pH range.

A further improvement in soil removal and in the reduction of resoiling can be achieved by modifying the surface of the nanoscale particles. This can be done, for example, by typical complexing agents so that the precipitation of Ca and Mg salts can be prevented. These compounds can be applied in such a quantity that they are present in the final composition in quantities of 1 to 8% by weight, preferably 3.0 to 6.0% by weight and more particularly 4.0 to 5.0% by weight, based on the final composition. They are normally applied to the surface of the particles.

A preferred class of complexing agents are the phosphonates. These preferred compounds include in particular organophosphonates such as, for example, 1-hydroxyethane-1,1-diphosphonic acid (HEDP), aminotri(methylenephosphonic acid) (ATMP), diethylenetriamine penta(methylenephosphonic acid) (DTPMP or DETPMP) and 2-phosphonobutane-1,2,4-tricarboxylic acid (PBS-AM) which are generally used in the form of their ammonium or alkali metal salts. The phosphonates are applied to the surface of the particles in such a quantity that they are present in the final composition in quantities of 0.01 to 2.0% by weight, preferably 0.05 to 1.5% by weight and more particularly 0.1 to 1.0% by weight.

Compounds which complex heavy metals may also be used as complexing agents. Suitable heavy metal complexing agents are, for example, ethylenediamine tetraacetic acid (EDTA) or nitrilotriacetic acid (NTA) in the form of the free acids or as alkali metal salts and derivatives of the above and also alkali metal salts of anionic polyelectrolytes, such as polymaleates and polysulfonates.

Other suitable complexing agents are low molecular weight hydroxycarboxylic acids, such as citric acid, tartaric acid, malic acid, lactic acid or gluconic acid and salts thereof, citric acid or sodium citrate being particularly preferred.

The modification of the particle surface may be carried out, for example, simply by stirring a suspension of the particles with the complexing agent which is absorbed onto the particle surface during stirring.

It is obvious to the expert that the complexing agents to be incorporated in the composition do not have to be applied in their entirety to the nanoscale particles. These compounds may also be directly incorporated either completely or in part.

A further increase in the wettability of the surfaces to be treated can also be achieved by the addition of hydrophilizing agents. Examples of suitable hydrophilizing agents are mono- or polyhydric alcohols, alkanolamines or glycolethers providing they are miscible with water. The hydrophilizing agents are preferably selected from ethanol, n- or i-propanol, butanols, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol monomethyl or monoethyl ether, diisopropylene glycol monomethyl or monoethyl ether, methoxy, ethoxy or butoxytriglycol, 1-butoxyethoxy-2-propanol, 3-methyl-3-methoxybutanol, propylene glycol t-butyl ether, alcohols, more particularly C₁₋₄ alkanols, glycols, polyethylene glycols, preferably with a molecular weight of 100 to 100,000 and more particularly in the range from 200 to 10,000 and polyols, such as sorbitol and mannitol, and polyethylene glycol liquid at room temperature, carboxylic acid esters, polyvinyl alcohols, ethylene oxide/propylene oxide block copolymers and mixtures of the above.

The particles used in accordance with the invention may be incorporated in liquid, gel-form or even solid compositions.

If the compositions are liquids or gels, they are generally water-based preparations which optionally contain other water-miscible organic solvents and thickeners. The water-miscible organic solvents include, for example, the compounds mentioned above as hydrophilizing agents. Liquid or gel-form compositions may be produced continuously or in batches simply by stirring the constituents, optionally at elevated temperature.

The viscosity of a liquid composition may be adjusted by addition of one or more thickening systems. The viscosity of liquid or gel-form compositions may be measured by standard methods (for example Brookfield RVD-VII viscosimeter, 20 r.p.m./20°, spindle 3) and is preferably in the range from 100 to 5,000 mpas.

Preferred compositions have viscosities of 200 to 4,000 mPas, values of 400 to 2,000 mPas being particularly preferred.

Suitable thickeners are inorganic or polymeric organic compounds. Mixtures of several additives may also be used.

The inorganic thickeners include, for example, polysilicic acids, clay minerals, such as montmorillonites, zeolites, silicas and bentonites.

The organic thickeners belong to the groups of natural polymers, modified natural polymers and fully synthetic polymers. These generally high molecular weight substances, which are also known as swelling agents, take up the liquids, swell in the process and finally change into viscous, true or colloidal solutions.

Natural polymers used as Theological additives are, for example, agar agar, carrageen, tragacanth, gum arabic, alginates, pectins, polyoses, guar gum, locust bean gum, starch, dextrins, gelatine and casein.

Modified natural materials belong above all to the group of modified starches and celluloses, of which carboxymethyl cellulose and other cellulose ethers, hydroxyethyl and propyl cellulose and gum ethers are mentioned as examples.

A large group of thickeners widely used in various fields of application are the fully synthetic polymers, such as polyacrylic and polymethacrylic compounds, vinyl polymers, polycarboxylic acids, polyethers, polyimines, polyamides and polyurethanes.

The thickeners may be present in a quantity of up to 10% by weight, preferably 0.05 to 5% by weight and more particularly 0.1 to 3% by weight, based on the final composition.

Other suitable thickeners are surface-active thickeners, for example alkylpolyglycosides, such as C₈₋₁₀ alkyl polyglucoside (APG® 220, Henkel KGaA); C₁₂₋₁₄ alkyl polyglucoside (APG® 600, Henkel KGaA).

Solid compositions include, for example, powders, compactates, such as granules and shaped bodies (tablets). The individual forms may be produced by methods known from the prior art, such as spray drying, granulation and tabletting.

The particles used in accordance with the invention may be used in particular in combination with surfactants preferably selected from nonionic, anionic, amphoteric and cationic surfactants and mixtures thereof.

The surfactants are used in a quantity of preferably 0.1 to 50% by weight, more preferably 0.1 to 35% by weight and most preferably 0.1 to 15% by weight, based on the composition.

The nonionic surfactants used are preferably alkoxylated, advantageously ethoxylated, more particularly primary alcohols preferably containing 8 to 18 carbon atoms and an average of 1 to 12 moles of ethylene oxide (EO) per mole of alcohol, in which the alcohol residue may be linear or, preferably, 2-methyl-branched or may contain linear and methyl-branched residues in the form of the mixtures typically present in oxoalcohol residues. However, alcohol ethoxylates containing linear residues of alcohols of native origin with 12 to 18 carbon atoms, for example coconut oil fatty alcohol, palm oil fatty alcohol, tallow fatty alcohol or oleyl alcohol, and an average of 2 to 8 EO per mole of alcohol are particularly preferred. Preferred ethoxylated alcohols include, for example, C₁₂₋₁₄ alcohols containing 3 EO to 7EO, C₉₋₁₁ alcohols containing 7 EO, C₁₃₋₁₅ alcohols containing 3 EO, 5 EO, 7 EO or 8 EO, C₁₂₋₁₈ alcohols containing 3 EO, 5 EO or 7 EO and mixtures thereof, such as mixtures of C₁₂₋₁₄ alcohol containing 3 EO and C₁₂₋₁₈ alcohol containing 7 EO. The degrees of ethoxylation mentioned are statistical mean values which, for a special product, may be either a whole number or a broken number. Preferred alcohol ethoxylates have a narrow homolog distribution (narrow range ethoxylates, NRE). In addition to these nonionic surfactants, fatty alcohols containing more than 12 EO may also be used. Examples of such fatty alcohols are tallow fatty alcohols containing 14 EO, 25 EO, 30 EO or 40 EO. Nonionic surfactants containing EO and PO groups together in the molecule may also be used in accordance with the invention. Block copolymers containing EO-PO block units or PO-EO block units and also EO-PO-EO copolymers and PO-EO-PO copolymers may be used. Mixed-alkoxylated nonionic surfactants in which EO and PO units are distributed statistically rather than in blocks may of course also be used. Products such as these can be obtained by the simultaneous action of ethylene and propylene oxide on fatty alcohols.

Particularly preferred examples of nonionic surfactants which provide for good drainage of water on hard surfaces are the fatty alcohol polyethylene glycol ethers, fatty alcohol polyethylene/polypropylene glycol ethers and mixed ethers which may optionally be end-capped.

Examples of fatty alcohol polyethylene glycol ethers are those corresponding to formula (I):

R¹O—(CH₂CH₂O)ₙ₁H (I)

in which R¹ is a linear or branched alkyl and/or alkenyl group containing 6 to 22 and preferably 12 to 18 carbon atoms and n1 is a number of 1 to 5.

The substances mentioned are known commercial products. Typical examples are products of the addition of on average 2 or 4 moles ethylene oxide onto technical C_{12/14} coconut fatty alcohol (Dehydol® LS-2 or LS-4, Henkel KGaA) or products of the addition of on average 4 moles ethylene oxide onto C_{14/15} oxoalcohols (Dobanol® 45-4, Shell). The products may have a conventional homolog distribution or even a narrow homolog distribution.

Fatty alcohol polyethylene/polypropylene glycol ethers are nonionic surfactants corresponding to formula (II):

CH₃

R²O—(CH₂CH₂O)ₙ₂(CH₂CHO)ₘ₂H (II)

in which R² is a linear or branched alkyl and/or alkenyl group containing 6 to 22 and preferably 12 to 18 carbon atoms, n2 is a number of 1 to 0 and m2 is a number of 1 to 4.

These substances are also known commercial products. Typical examples are products of the addition of on average 5 moles ethylene oxide and 4 moles propylene oxide onto technical C_{12/14} coconut oil fatty alcohol (Dehydol® LS-54, Henkel KGaA) or 6.4 moles ethylene oxide and 1.2 moles propylene oxide onto technical C_{10/14} coconut oil fatty alcohol (Dehydol® LS-980, Henkel KGaA).

Mixed ethers are understood to be end-capped fatty alcohol polyglycol ethers corresponding to formula (III):

CH₃

R³O—(CH₂CH₂O)ₙ₃(CH₂CHO)ₘ₃—R⁴ (III)

in which R³ is a linear or branched alkyl and/or alkenyl group containing 6 to 22 and preferably 12 to 18 carbon atoms, n3 is a number of 1 to 10, m3 is a number of 0 or 1 to 4 and R⁴ is an alkyl group containing 1 to 4 carbon atoms or a benzyl group.

Typical examples are mixed ethers corresponding to formula (III) in which R³ is a technical C_{12/14} coconut fatty alkyl group, n3 has a value of 5 or 10, m3 has a value of 0 and R⁴ is a butyl group (Dehypon® LS-54 or LS-104, Henkel KGaA). The use of butyl- or benzyl-end-capped mixed ethers is particularly preferred for applicational reasons.

Hydroxyalkyl polyethylene glycol ethers are compounds corresponding to general formula (IV):

OH R⁷

R⁵—CH—CH—(OCH₂CH₂O)ₙ₄—OR⁶ (IV)

in which R⁵ is hydrogen or a linear alkyl group containing 1 to 16 carbon atoms, R⁶ is a linear or branched alkyl group containing 4 to 8 carbon atoms, R⁷ is hydrogen or a C₁₋₁₆ alkyl group and n4 is a number of 7 to 30, with the proviso that the total number of carbon atoms in R⁵ and R⁷ is 6 to 16.

In addition, other nonionic surfactants which may be used are alkyl glycosides corresponding to the general formula RO(G)ₓ where R is a primary, linear or methyl-branched, more particularly 2-methyl-branched, aliphatic radical containing 8 to 22 and preferably 12 to 18 carbon atoms, G is a glycose unit containing 5 or 6 carbon atoms, preferably glucose. The degree of oligomerization x, which indicates the distribution of monoglycosides and oligoglycosides, is between 1 and 10 and preferably between 1.2 and 1.4.

Another class of nonionic surfactants which may be used in particular in solid compositions are alkoxylated, preferably ethoxylated or ethoxylated and propoxylated, fatty acid alkyl esters preferably containing 1 to 4 carbon atoms in the alkyl chain.

Nonionic surfactants of the amine oxide type, for example N-cocoalkyl-N,N-dimethylamine oxide and N-tallowalkyl-N,N-dihydroxyethyl amine oxide, and the fatty acid alkanolamide type are also suitable. The quantity in which these nonionic surfactants are used is preferably no more, in particular no more than half, the quantity of ethoxylated fatty alcohols used.

Other suitable surfactants are polyhydroxyfatty acid amides corresponding to formula (V):

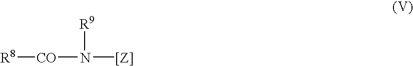

in which R⁸CO is an aliphatic acyl group containing 6 to 22 carbon atoms, R⁹ is hydrogen, an alkyl or hydroxyalkyl group containing 1 to 4 carbon atoms and [Z] is a linear or branched polyhydroxyalkyl group containing 3 to 10 carbon atoms and 3 to 10 hydroxyl groups. The polyhydroxyfatty acid amides are known substances which may normally be obtained by reductive amination of a reducing sugar with ammonia, an alkylamine or an alkanolamine and subsequent acylation with a fatty acid, a fatty acid alkyl ester or a fatty acid chloride.

The group of polyhydroxyfatty acid amides also includes compounds corresponding to formula (VI):

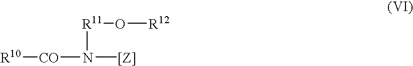

in which R¹⁰ is a linear or branched alkyl or alkenyl group containing 7 to 12 carbon atoms, R¹¹ is a linear, branched or cyclic alkyl group or an aryl group containing 2 to 8 carbon atoms and R¹² is a linear, branched or cyclic alkyl group or an aryl group or an oxyalkyl group containing 1 to 8 carbon atoms, C₁₋₄ alkyl or phenyl groups being preferred, and [Z] is a linear polyhydroxyalkyl group, of which the alkyl chain is substituted by at least two hydroxyl groups, or alkoxylated, preferably ethoxylated or propoxylated, derivatives of that group.

[Z] is preferably obtained by reductive amination of a reduced sugar, for example glucose, fructose, maltose, lactose, galactose, mannose or xylose. The N-alkoxy- or N-aryloxy-substituted compounds may then be converted into the required polyhydroxyfatty acid amides by reaction with fatty acid methyl esters in the presence of an alkoxide as catalyst, for example in accordance with the teaching of International patent application WO-A-95/07331.

Suitable anionic surfactants are, for example, those of the sulfonate and sulfate type. Suitable surfactants of the sulfonate type are preferably C₉₋₁₃ alkyl benzenesulfonates, olefin sulfonates, i.e. mixtures of alkene and hydroxyalkane sulfonates, and the disulfonates obtained, for example, from C₁₂₋₁₈ monoolefins with an internal or terminal double bond by sulfonation with gaseous sulfur trioxide and subsequent alkaline or acidic hydrolysis of the sulfonation products. Other suitable surfactants of the sulfonate type are the alkane sulfonates obtained from C₁₂₋₁₈ alkanes, for example by sulfochlorination or sulfoxidation and subsequent hydrolysis or neutralization. The esters of α-sulfofatty acids (ester sulfonates), for example the α-sulfonated methyl esters of hydrogenated coconut oil, palm kernel oil or tallow fatty acids, are also suitable.

Preferred alk(en)yl sulfates are the alkali metal salts and, in particular, the sodium salts of the sulfuric acid semiesters of C₁₂₋₁₈ fatty alcohols, for example cocofatty alcohol, tallow fatty alcohol, lauryl, myristyl, cetyl or stearyl alcohol, or C₁₀₋₂₀ oxoalcohols and the corresponding semiesters of secondary alcohols with the same chain length. Other preferred alk(en)yl sulfates are those with the chain length mentioned which contain a synthetic, linear alkyl chain based on a petrochemical. C₁₂₋₁₆ alkyl sulfates, C₁₂₋₁₅ alkyl sulfates and C₁₄₋₁₅ alkyl sulfates are preferred from the point of view of washing technology. Other suitable anionic surfactants are 2,3-alkyl sulfates which may be produced, for example, in accordance with U.S. Pat. No. 3,234,258 or U.S. Pat. No. 5,075,041 and which are commercially obtainable as products of the Shell Oil Company under the name of DAN®.

Other suitable anionic surfactants are sulfonated fatty acid glycerol esters. Fatty acid glycerol esters in the context of the present invention are the monoesters, diesters and triesters and mixtures thereof which are obtained where production is carried out by esterification of a monoglycerol with 1 to 3 moles of fatty acid or in the transesterification of triglycerides with 0.3 to 2 moles of glycerol. Preferred sulfonated fatty acid glycerol esters are the sulfonation products of saturated fatty acids containing 6 to 22 carbon atoms, for example caproic acid, caprylic acid, capric acid, myristic acid, lauric acid, palmitic acid, stearic acid or behenic acid.

The sulfuric acid monoesters of linear or branched C₇₋₂₁ alcohols ethoxylated with 1 to 6 moles of ethylene oxide, such as 2-methyl-branched C₉₋₁₁ alcohols containing on average 3.5 moles of ethylene oxide (EO) or C₁₂₋₁₈ fatty alcohols containing 1 to 4 EO, are also suitable. In view of their high foaming capacity, they are only used in relatively small quantities, for example in quantities of 1 to 5% by weight, in cleaning compositions.

Other suitable anionic surfactants are the salts of alkyl sulfosuccinic acid which are also known as sulfosuccinates or as sulfosuccinic acid esters and which represent monoesters and/or diesters of sulfosuccinic acid with alcohols, preferably fatty alcohols and, more particularly, ethoxylated fatty alcohols. Preferred sulfosuccinates contain C₈₋₁₈ fatty alcohol residues or mixtures thereof. Particularly preferred sulfosuccinates contain a fatty alcohol moiety derived from ethoxylated fatty alcohols which, considered in isolation, represent nonionic surfactants (for a description, see below). Of these sulfosuccinates, those of which the fatty alcohol moieties are derived from narrow-range ethoxylated fatty alcohols are particularly preferred. Alk(en)yl succinic acid preferably containing 8 to 18 carbon atoms in the alk(en)yl chain or salts thereof may also be used.

Other suitable anionic surfactants are, in particular, soaps which are used above all in powder-form compositions and at relatively high pH values. Suitable soaps are saturated and unsaturated fatty acid soaps, such as the salts of lauric acid, myristic acid, palmitic acid, stearic acid, hydrogenated erucic acid and behenic acid, and soap mixtures derived in particular from natural fatty acids, for example coconut oil, palm kernel oil, olive oil or tallow fatty acids.

The anionic surfactants, including the soaps, may be present in the form of their sodium, potassium or ammonium salts and as soluble salts of organic bases, such as mono-, di- or triethanolamine. The anionic surfactants are preferably present in the form of their sodium or potassium salts and, more preferably, in the form of their sodium salts.

Other suitable surfactants are so-called gemini surfactants. Gemini surfactants are generally understood to be compounds which contain two hydrophilic groups and two hydrophobic groups per molecule. These groups are generally separated from one another by a so-called “spacer”. The spacer is generally a carbon chain which should be long enough for the hydrophilic groups to have a sufficient spacing to be able to act independently of one another. Gemini surfactants are generally distinguished by an unusually low critical micelle concentration and by an ability to reduce the surface tension of water to a considerable extent. In exceptional cases, however, gemini surfactants are not only understood to be “dimeric” surfactants, but also “trimeric” surfactants. Suitable gemini surfactants are, for example, sulfated hydroxy mixed ethers, dimer alcohol bis- and trimer alcohol tris-sulfates and -ether sulfates. End-capped dimeric and trimeric mixed ethers are distinguished in particular by their bi- and multifunctionality. Thus, the end-capped surfactants mentioned exhibit good wetting properties and are low-foaming so that they are particularly suitable for use in machine washing or cleaning processes. However, gemini polyhydroxyfatty amides or poly-polyhydroxyfatty acid amides may also be used.

Examples of cationic surfactants are quaternary ammonium compounds, cationic polymers and emulsifiers of the type used in hair care preparations and also in fabric conditioners.

Suitable examples are quaternary ammonium compounds corresponding to formulae (VII) and (VIII):

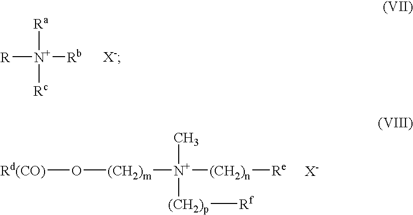

where R and R^{a} represent an acyclic alkyl group containing 12 to 24 carbon atoms, R^{b} is a saturated C₁₋₄ alkyl or hydroxyalkyl group, R^{c} is either the same as R, R^{a} or R^{b} or represents an aromatic radical. X⁻ is either a halide, methosulfate, methophosphate or phosphate ion or a mixture thereof. Examples of cationic compounds corresponding to formula (VII) are didecyl dimethyl ammonium chloride, ditallow dimethyl ammonium chloride or dihexadecyl ammonium chloride.

Compounds corresponding to formula (VIII) are so-called esterquats. Esterquats are distinguished by excellent biodegradability. In that formula, R^{d} is an aliphatic acyl group containing 12 to 22 carbon atoms and 0, 1, 2 or 3 double bonds, R^{e} is H, OH or O(CO)R^{f}, R^{g} independently of R^{f} stands for H, OH or O(CO)R^{h}, R^{g} and R^{h} independently of one another representing an aliphatic acyl group containing 12 to 22 carbon atoms and 0, 1, 2 or 3 double bonds. m, n and p independently of one another can have a value of 1, 2 or 3. X⁻ can be a halide, methosulfate, methophosphate or phosphate ion or a mixture thereof. Preferred compounds contain the group O(CO)R^{g} for R^{d} and C₁₆₋₁₈ alkyl groups for R^{d} and R^{g}. Particularly preferred compounds are those in which R¹ is also OH. Examples of compounds corresponding to formula (VIII) are methyl-N-(2-hydroxyethyl)-N,N-di(tallowacyloxyethyl)-ammonium methosulfate, bis-(palmitoyl)-ethyl hydroxyethyl methyl ammonium methosulfate or methyl-N,N-bis-(acyloxyethyl)-N-(2-hydroxyethyl)-ammonium methosulfate. If quaternized compounds corresponding to formula (VIII) containing unsaturated alkyl chains are used, those acyl groups of which the corresponding fatty acids have an iodine value of 5 to 80, preferably 10 to 60 and more particularly 15 to 45 and which have a cis-:trans-isomer ratio (in % by weight) of greater than 30:70, preferably greater than 50:50 and more particularly greater than 70:30 are preferred. Commercially available examples are the methyl hydroxyalkyl dialkoyloxyalkyl ammonium methosulfates marketed by Stepan under the name of Stepantex® or the Cognis products known under the name of Dehyquart® or the Goldschmidt-Witco products known under the name of Rewoquat®. Other preferred compounds are the diesterquats corresponding to formula (IX) which are obtainable under the name of Rewoquat® W 222 LM or CR 3099 and, besides softness, also provide for stability and color protection.

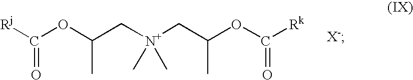

In formula (IX), R^{j} and R^{k} independently of one another each represent an aliphatic acyl group containing 12 to 22 carbon atoms and 0, 1, 2 or 3 double bonds.

Besides the quaternary compounds described above, other known compounds may also be used, including for example quaternary imidazolinium compounds corresponding to formula (X):

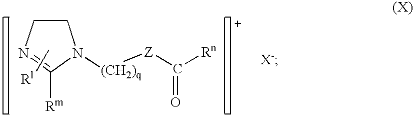

in which R^{l} represents H or a saturated alkyl group containing 1 to 4 carbon atoms, R^{m} and Rⁿ independently of one another represent an aliphatic, saturated or unsaturated alkyl group containing 12 to 18 carbon atoms, R^{m} alternatively may also represent O(CO)R^{o}, R^{o} being an aliphatic, saturated or unsaturated alkyl group containing 12 to 18 carbon atoms, and Z is an NH group or oxygen and X⁻ is an anion. q may be an integer of 1 to 4.

Other suitable quaternary compounds correspond to formula (XI):

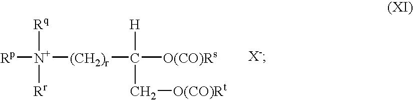

where R^{p}, R^{q} and R^{r} independently of one another represent a C₁₋₄ alkyl, alkenyl or hydroxyalkyl group, R^{s} and R^{t} independently of one another represent a C₈₋₂₈ alkyl group and r is a number of 1 to 5.

Besides the compounds corresponding to formulae (VII) and (VIII), short-chain, water-soluble quaternary ammonium compounds may also be used, including trihydroxyethyl methyl ammonium methosulfate or the alkyl trimethyl ammonium chlorides, dialkyl dimethyl ammonium chlorides and trialkyl methyl ammonium chlorides, for example cetyl trimethyl ammonium chloride, stearyl trimethyl ammonium chloride, distearyl dimethyl ammonium chloride, lauryl dimethyl ammonium chloride, lauryl dimethyl benzyl ammonium chloride and tricetyl methyl ammonium chloride.

Protonated alkylamine compounds with a fabric-softening effect and non-quaternized protonated precursors of the cationic emulsifiers are also suitable.

Other cationic compounds suitable for use in accordance with the invention are the quaternized protein hydrolyzates.

Suitable cationic polymers are the polyquaternium polymers listed in the CTFA Cosmetic Ingredient Dictionary (The Cosmetic, Toiletry and Fragrance Association, Inc., 1997), more particularly the polyquaternium-6, polyquaternium-7 and polyquaternium-10 polymers (Ucare Polymer IR 400, Amerchol) also known as merquats, polyquaternium-4 copolymers, such as graft copolymers with a cellulose skeleton and quaternary ammonium groups attached by allyl dimethyl ammonium chloride, cationic cellulose derivatives, such as cationic guar, such as guar hydroxypropyl triammonium chloride, and similar quaternized guar derivatives (for example Cosmedia Guar, Cognis GmbH), cationic quaternary sugar derivatives (cationic alkyl polyglucosides), for example the commercial product Glucquat® 100 (CTFA name: Lauryl Methyl Gluceth-10 Hydroxypropyl Dimonium Chloride), copolymers of PVP and dimethyl aminomethacrylate, copolymers of vinyl imidazole and vinyl pyrrolidone, aminosilicon polymers and copolymers.

Polyquaternized polymers (for example Luviquat Care, BASF) and chitin-based cationic biopolymers and derivatives thereof, for example the polymer commercially obtainable as Chitosan® (Cognis), are also suitable.

Cationic silicone oils are also suitable for the purposes of the invention, including for example the commercially available products Q2-7224 (a stabilized trimethylsilyl amodimethicone, Dow Corning), Dow Corning 929 Emulsion (containing a hydroxylamino-modified silicone which is also known as amodimethicone), SM-2059 (General Electric), SLM-55067 (Wacker), Abil®-Quat 3270 and 3272 (diquaternary polydimethylsiloxanes, quaternium-80, Goldschmidt-Rewo) and siliconequat Rewoquat® SQ 1 (Tegopren® 6922, Goldschmidt-Rewo).

Other suitable compounds correspond to the following formula:

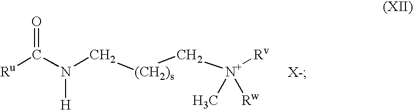

and may be alkylamidoamines in their non-quaternized form or, as illustrated, their quaternized form. In formula (XII), R^{u} may be an aliphatic acyl group containing 12 to 22 carbon atoms and 0, 1, 2 or 3 double bonds. s may assume a value of 0 to 5. R^{v} and R^{w} independently of one another represent H, C₁₋₄ alkyl or hydroxyalkyl. Preferred compounds are fatty acid amidoamines, such as the stearylamidopropyl dimethylamine obtainable under the name of Tego Amid® S 18 or the 3-tallowamidopropyl trimethylammonium methosulfate obtainable as Stepantex® X 9124, which, besides a good conditioning effect, are also distinguished by a dye transfer inhibiting effect and by ready biodegradability.

The particles used in accordance with the invention are preferably incorporated in textile finishing compositions, laundry detergents, textile pretreatment or aftertreatment compositions.

Accordingly, the present invention also relates to textile treatment compositions which are characterized in that they contain particles with a particle size of 5 to 500 nm for improving soil removal from and/or reducing the resoiling of textile surfaces.

Besides the particles used in accordance with the invention, the compositions may also contain the surfactants described in the foregoing and other components typically encountered in detergents and cleaning compositions.

Other components which may be used are, for example, builders, more particularly zeolites, silicates, carbonates, organic co-builders and—unless there are ecological objections to their use—the phosphates.

Suitable crystalline layer-form sodium silicates correspond to the general formula NaMSiₓO₂ₓ₊₁·y H₂O, where M is sodium or hydrogen, x is a number of 1.9 to 4 and y is a number of 0 to 20, preferred values for x being 2, 3 or 4. Preferred crystalline layer silicates corresponding to the above formula are those in which M is sodium and x assumes the value 2 or 3. Both β- and δ-sodium disilicates Na₂Si₂O₅·y H₂O are particularly preferred.

Other useful builders are amorphous sodium silicates with a modulus (Na₂O:SiO₂ ratio) of 1:2 to 1:3.3, preferably 1:2 to 1:2.8 and more preferably 1:2 to 1:2.6 which dissolve with delay and exhibit multiple wash cycle properties. The delay in dissolution in relation to conventional amorphous sodium silicates can have been obtained in various ways, for example by surface treatment, compounding, compacting or by overdrying. In the context of the invention, the term “amorphous” is also understood to encompass “X-ray amorphous”. In other words, the silicates do not produce any of the sharp X-ray reflexes typical of crystalline substances in X-ray diffraction experiments, but at best one or more maxima of the scattered X-radiation which have a width of several degrees of the diffraction angle. However, particularly good builder properties may even be achieved where the silicate particles produce crooked or even sharp diffraction maxima in electron diffraction experiments. This may be interpreted to mean that the products have microcrystalline regions between 10 and a few hundred nm in size, values of up to at most 50 nm and, more particularly, up to at most 20 nm being preferred. Compacted amorphous silicates, compounded amorphous silicates and overdried X-ray-amorphous silicates are particularly preferred.

The finely crystalline, synthetic zeolite containing bound water used in accordance with the invention is preferably zeolite A and/or zeolite P. Zeolite MAP® (Crosfield) is a particularly preferred P-type zeolite. However, zeolite X and mixtures of A, X and/or P are also suitable.

Zeolites of the faujasite type are mentioned as other preferred and particularly suitable zeolites. Together with zeolites X and Y, the mineral faujasite belongs to the faujasite types within zeolite structure group 4 which is characterized by the double 6-membered ring subunit D6R (cf. Donald W. Breck: “Zeolite Molecular Sieves”, John Wiley & Sons, New York, London, Sydney, Toronto, 1974, page 92). Besides the faujasite types mentioned, the minerals chabasite and gmelinite and the synthetic zeolites R (chabasite type), S (gmelinite type), L and ZK-5 belong to zeolite structure group 4. The last two of these synthetic zeolites do not have any mineral analogs.

Faujasite zeolites are made up of β-cages tetrahedrally linked by D6R subunits, the β-cages being arranged similarly to the carbon atoms in diamond. The three-dimensional framework of the faujasite zeolites used in the process according to the invention has pores 2.2 and 7.4 Å in size. In addition, the elementary cell contains eight cavities each ca. 13 Å in diameter and may be described by the formula Na₈₆[(AlO₂)₈₆(SiO₂)₁₀₆]·264 H₂O. The framework of the zeolite X contains a void volume of around 50%, based on the dehydrated crystal, which represents the largest empty space of all known zeolites (zeolite Y: ca. 48% void volume, faujasite: ca. 47% void volume). (All data from: Donald W. Breck: “Zeolite Molecular Sieves”, John Wiley & Sons, New York, London, Sydney, Toronto, 1974, pages 145, 176, 177).

In the context of the present invention, the expression “faujasite zeolite” characterizes all three zeolites which form the faujasite subgroup of zeolite structure group 4. Besides zeolite X, zeolite Y and faujasite and faujasite and mixtures of these compounds may also be used, pure zeolite X being preferred.

Mixtures or co-crystallizates of faujasite zeolites with other zeolites, which do not necessarily have to belong to zeolite structure group 4, may also be used.

Aluminium silicates which may also be used are commercially obtainable and the methods for their production are described in standard works.

Examples of commercially available X-type zeolites may be described by the following formulae:

Na₈₆[(AlO₂)₈₆(SiO₂)₁₀₆]·x H₂O,

K₈₆[(AlO₂)₈₆(SiO₂)₁₀₆]·x H₂O,

Ca₄₀Na₆[(AlO₂)₈₆(SiO₂)₁₀₆]·x H₂O,

Sr₂₁Ba₂₂[(AlO₂)₈₆(SiO₂)₁₀₆]·x H₂O,

in which x may assume a value of 0 to 276 and which have pore sizes of 8.0 to 8.4 Å.

For example, a co-crystallizate of zeolite X and zeolite A (ca. 80% by weight zeolite X), which is marketed by CONDEA Augusta S.p.A. under the name of VEGOBOND AX® and which may be described by the following formula:

nNa₂O·(1−n)K₂O·Al₂O₃·(2-2.5)SiO₂(3.5-5.5) H₂O

is commercially obtainable and may be used with advantage in the process according to the invention. The zeolite may serve as a builder in a granular compound and may be also be used for “powdering” the entire mixture to be tabletted, both options normally being used to incorporate the zeolite in the compound. Suitable zeolites have a mean particle size of less than 10 μm (volume distribution, as measured by the Coulter Counter Method) and contain preferably 18 to 22% by weight and more preferably 20 to 22% by weight of bound water.

The generally known phosphates may of course also be used as builders providing their use should not be avoided on ecological grounds. Among the large number of commercially available phosphates, alkali metal phosphates, hydrogen and dihydrogen phosphates have the greatest importance in the detergent industry, pentasodium triphosphate and pentapotassium triphosphate (sodium and potassium tripolyphosphate) being particularly preferred.

“Alkali metal phosphates” is the collective term for the alkali metal (more particularly sodium and potassium) salts of the various phosphoric acids, including metaphosphoric acids (HPO₃)ₙ and orthophosphoric acid (H₃PO₄) and representatives of higher molecular weight. The phosphates combine several advantages: they act as alkalinity sources, prevent lime deposits on machine parts and lime incrustations in fabrics and, in addition, contribute towards the cleaning effect.

Suitable organic cobuilders are, in particular, polycarboxylates/polycarboxylic acids, polymeric polycarboxylates, aspartic acid, polyacetals, dextrins, other organic cobuilders (see below) and phosphonates. These classes of substances are described in the following.

Useful organic builders are, for example, the polycarboxylic acids usable in the form of their sodium salts, polycarboxylic acids in this context being understood to be carboxylic acids which bear more than one acid function. Examples of such carboxylic acids are citric acid, adipic acid, succinic acid, glutaric acid, malic acid, tartaric acid, maleic acid, fumaric acid, sugar acids, aminocarboxylic acids, nitrilotriacetic acid (NTA), providing its use is not ecologically unsafe, and mixtures thereof. Preferred salts are the salts of the polycarboxylic acids, such as citric acid, adipic acid, succinic acid, glutaric acid, tartaric acid, sugar acids and mixtures thereof.

The acids per se may also be used. Besides their builder effect, the acids also typically have the property of an acidifying component and, hence, also serve to establish a relatively low and mild pH value in detergents. Citric acid, succinic acid, glutaric acid, adipic acid, gluconic acid and mixtures thereof are particularly mentioned in this regard.

Other suitable builders are polymeric polycarboxylates such as, for example, the alkali metal salts of polyacrylic or polymethacrylic acid, for example those with a relative molecular weight of 500 to 70,000 g/mole.

The molecular weights mentioned in this specification for polymeric polycarboxylates are weight-average molecular weights M_{w} of the particular acid form which, basically, were determined by gel permeation chromatography (GPC) using a UV detector. The measurement was carried out against an external polyacrylic acid standard which provides realistic molecular weight values by virtue of its structural similarity to the polymers investigated. These values differ distinctly from the molecular weights measured against polystyrene sulfonic acids as standard. The molecular weights measured against polystyrene sulfonic acids are generally higher than the molecular weights mentioned in this specification.

Particularly suitable polymers are polyacrylates which preferably have a molecular weight of 2,000 to 20,000 g/mole. By virtue of their superior solubility, preferred representatives of this group are the short-chain polyacrylates which have molecular weights of 2,000 to 10,000 g/mole and, more particularly, 3,000 to 5,000 g/mole.

Also suitable are copolymeric polycarboxylates, particularly those of acrylic acid with methacrylic acid and those of acrylic acid or methacrylic acid with maleic acid. Acrylic acid/maleic acid copolymers containing 50 to 90% by weight of acrylic acid and 50 to 10% by weight of maleic acid have proved to be particularly suitable. Their relative molecular weights, based on the free acids, are generally in the range from 2,000 to 70,000 g/mole, preferably in the range from 20,000 to 50,000 g/mole and more preferably in the range from 30,000 to 40,000 g/mole.

The (co)polymeric polycarboxylates may be used either in powder form or in the form of an aqueous solution. The content of (co)polymeric polycarboxylates is preferably from 0.5 to 20% by weight and more preferably from 3 to 10% by weight.

In order to improve solubility in water, the polymers may also contain allyl sulfonic acids, such as allyloxybenzene sulfonic acid and methallyl sulfonic acid, as monomer.

Other particularly preferred polymers are biodegradable polymers of more than two different monomer units, for example those which contain salts of acrylic acid and maleic acid and vinyl alcohol or vinyl alcohol derivatives as monomers or those which contain salts of acrylic acid and 2-alkylallyl sulfonic acid and sugar derivatives as monomers.

Other preferred copolymers are those which preferably contain acrolein and acrylic acid/acrylic acid salts or acrolein and vinyl acetate as monomers.

Other preferred builders are polymeric aminodicarboxylic acids, salts or precursors thereof. Polyaspartic acids or salts and derivatives thereof is/are particularly preferred.

Other suitable builders are polyacetals which may be obtained by reaction of dialdehydes with polyol carboxylic acids containing 5 to 7 carbon atoms and at least three hydroxyl groups. Preferred polyacetals are obtained from dialdehydes, such as glyoxal, glutaraldehyde, terephthalaldehyde and mixtures thereof and from polyol carboxylic acids, such as gluconic acid and/or glucoheptonic acid.

Other suitable organic builders are dextrins, for example oligomers or polymers of carbohydrates which may be obtained by partial hydrolysis of starches. The hydrolysis may be carried out by standard methods, for example acid- or enzyme-catalyzed methods. The end products are preferably hydrolysis products with average molecular weights of 400 to 500,000 g/mole. A polysaccharide with a dextrose equivalent (DE) of 0.5 to 40 and, more particularly, 2 to 30 is preferred, the DE being an accepted measure of the reducing effect of a polysaccharide by comparison with dextrose which has a DE of 100. Both maltodextrins with a DE of 3 to 20 and dry glucose sirups with a DE of 20 to 37 and also so-called yellow dextrins and white dextrins with relatively high molecular weights of 2,000 to 30,000 g/mole may be used.

The oxidized derivatives of such dextrins are their reaction products with oxidizing agents which are capable of oxidizing at least one alcohol function of the saccharide ring to the carboxylic acid function. An oxidized oligosaccharide, such as a product oxidized at C₆ of the saccharide ring, is also suitable.

Other suitable co-builders are oxydisuccinates and other derivatives of disuccinates, preferably ethylenediamine disuccinate. Ethylenediamine-N,N′-disuccinate (EDDS) is preferably used in the form of its sodium or magnesium salts. Glycerol disuccinates and glycerol trisuccinates are also preferred in this connection. The quantities used in zeolite-containing and/or silicate-containing formulations are from 3 to 15% by weight.

Other useful organic co-builders are, for example, acetylated hydroxycarboxylic acids and salts thereof which may optionally be present in lactone form and which contain at least 4 carbon atoms, at least one hydroxy group and at most two acid groups.

Another class of substances with co-builder properties are the phosphonates. These compounds have already been described as suitable substances for modifying the particle surfaces. They may also be directly used as individual substances.

In addition, any compounds which are capable of forming complexes with alkaline earth metal ions may be used as co-builders.

In addition, the compositions produced may contain any of the substances typically used in detergents, such as enzymes, bleaching agents, bleach activators, complexing agents, redeposition inhibitors, foam inhibitors, inorganic salts, solvents, pH adjusters, perfumes, perfume carriers, fluorescers, dyes, hydrotropes, silicone oils, other soil release compounds, optical brighteners, discoloration inhibitors, shrinkage inhibitors, anti-crease agents, dye transfer inhibitors, antimicrobial agents, germicides, fungicides, antioxidants, corrosion inhibitors, antistatic agents, ironing aids, waterproofing and impregnating agents, swelling and non-slip agents, UV absorbers and mixtures thereof.

Enzymes suitable for use in the compositions are enzymes from the class of oxidases, proteases, lipases, cutinases, amylases, pullulanases, cellulases, hemicellulases, xylanases and peroxidases and mixtures thereof, for example proteases, such as BLAP®, Optimase®, Opticlean®, Maxacal®, Maxapem®, Alcalase®, Esperase® and/or Savinase®; amylases, such as Termamyl®, Amylase-LT®, Maxamyl®, Duramyl® and/or Purafect® OxAm; lipases, such as Lipolase®, Lipomax®, Lumafast® and/or Lipozym®; cellulases, such as Celluzyme® and/or Carazeme®. Particularly suitable enzymes are those obtained from fungi or bacteria, such as Bacillus subtilis, Bacillus licheniformis, Streptomyces griseus, Humicola lanuginosa, Humicola insolens, Pseudomonas pseudoalcaligenes or Pseudomonas cepacia. As described for example in European patent 0 564 476 or in International patent application WO 94/23005, the enzymes optionally used may be adsorbed onto supports and/or encapsulated in membrane materials to protect them against premature inactivation. They are present in the compositions according to the invention in quantities of preferably up to 10% by weight and, more preferably, between 0.2% by weight and 2% by weight, enzymes stabilized against oxidative degradation being particularly preferred.

Among the compounds yielding H₂O₂ in water which serve as bleaching agents, sodium perborate tetrahydrate, sodium perborate monohydrate and sodium percarbonate are particularly important. Other useful bleaching agents are, for example, persulfates and mixed salts with persulfates, such as the salts commercially available as CAROAT®, peroxypyrophosphates, citrate perhydrates and H₂O₂-yielding peracidic salts or peracids, such as perbenzoates, peroxophthalates, diperazelaic acid, diperdodecanedioic acid or phthaloiminoperacids, such as phthaliminopercaproic acid. Organic per acids, alkali metal perborates and/or alkali metal percarbonates in quantities of 0.1 to 40% by weight, preferably 3 to 30% by weight and more particularly 5 to 25% by weight are preferably used.

In order to obtain an improved bleaching effect where washing is carried out at temperatures of 60° C. or lower and particularly in the pretreatment of laundry, bleach activators may be incorporated. Suitable bleach activators are compounds which form aliphatic peroxocarboxylic acids containing preferably 1 to 10 carbon atoms and more preferably 2 to 4 carbon atoms and/or optionally substituted perbenzoic acid under perhydrolysis conditions. Substances bearing O- and/or N-acyl groups with the number of carbon atoms mentioned and/or optionally substituted benzoyl groups are suitable. Preferred bleach activators are polyacylated alkylenediamines, more particularly tetraacetyl ethylenediamine (TAED), acylated triazine derivatives, more particularly 1,5-diacetyl-2,4-dioxohexahydro-1,3,5-triazine (DADHT), acylated glycolurils, more particularly 1,3,4,6-tetraacetyl glycoluril (TAGU), N-acylimides, more particularly N-nonanoyl succinimide (NOSI), acylated phenol sulfonates, more particularly n-nonanoyl or isononanoyloxybenzenesulfonate (n- or iso-NOBS), acylated hydrocarboxylic acids, such as triethyl-O-acetyl citrate (TEOC), carboxylic anhydrides, more particularly phthalic anhydride, isatoic anhydride and/or succinic anhydride, carboxylic acid amides, such as N-methyl diacetamide, glycolide, acylated polyhydric alcohols, more particularly triacetin, ethylene glycol diacetate, isopropenyl acetate, 2,5-diacetoxy-2,5-dihydrofuran and the enol esters known from German patent applications DE 196 16 693 and DE 196 16 767, acetylated sorbitol and mannitol and the mixtures thereof (SORMAN) described in European patent application EP 0 525 239, acylated sugar derivatives, more particularly pentaacetyl glucose (PAG), pentaacetyl fructose, tetraacetyl xylose and octaacetyl lactose, and acetylated, optionally N-alkylated glucamine and gluconolactone, triazole or triazole derivatives and/or particulate caprolactams and/or caprolactam derivatives, preferably N-acylated lactams, for example N-benzoyl caprolactam and N-acetyl caprolactam, which are known from International patent applications WO-A-94/27970, WO-A-94/28102, WO-A-94/28103, WO-A-95/00626, WO-A-95/14759 and WO-A-95/17498. The substituted hydrophilic acyl acetals known from German patent application DE-A-196 16 769 and the acyl lactams described in German patent application DE-A-196 16 770 and in International patent application WO-A-95/14075 are also preferably used. The combinations of conventional bleach activators known from German patent application DE-A-44 43 177 may also be used. Nitrile derivatives, such as cyanopyridines, nitrile quats, for example N-alkyl ammonium acetonitriles, and/or cyanamide derivatives may also be used. Preferred bleach activators are sodium-4-(octanoyloxy)-benzene sulfonate, n-nonanoyl or isononanoyloxybenzenesulfonate (n- or iso-NOBS), undecenoyloxybenzenesulfonate (UDOBS), sodium dodecanoyloxybenzenesulfonate (DOBS), decanoyloxybenzoic acid (DOBA, OBC 10) and/or dodecanoyloxybenzenesulfonate (OBS 12) and N-methyl morpholiium acetonitrile (MMA). Bleach activators such as these are present in the usual quantities of 0.01 to 20% by weight, preferably in quantities of 0.1% by weight to 15% by weight and more preferably in quantities of 1% by weight to 10% by weight, based on the composition as a whole.

In addition to or instead of the conventional bleach activators mentioned above, so-called bleach catalysts may also be incorporated. Bleach catalysts are bleach-boosting transition metal salts or transition metal complexes such as, for example, manganese-, iron-, cobalt-, ruthenium- or molybdenum-salen complexes or carbonyl complexes. Manganese, iron, cobalt, ruthenium, molybdenum, titanium, vanadium and copper complexes with nitrogen-containing tripod ligands and cobalt-, iron-, copper- and ruthenium-ammine complexes may also be used as bleach catalysts, the particularly compounds described in DE 197 09 284 A1.

Depending on the particular formulation, laundry detergents can be used for pretreating laundry, for washing and for aftertreatment, i.e. as fabric softeners, etc. Their use in an aftertreatment composition (for example fabric softener) can lead primarily to an improvement in hydrophilia, although the result is only visible at a later stage, i.e. in a washing process carried out after wearing.

Pretreatment compositions containing the particles used in accordance with the invention preferably contain anionic and nonionic surfactants, optionally bleaching agents and other components as further ingredients. If the pretreatment compositions are present in the form of sprays, they generally contain solvents, such as spirit.

Liquid or gel-form laundry detergents may contain 5 to 40% by weight and preferably 15 to 30% by weight of liquid nonionic surfactants, 1 to 20% by weight and preferably 5 to 15% by weight of anionic surfactants, up to 10% by weight and preferably up to 5% by weight of sugar surfactants, up to 20% by weight and preferably 5 to 15% by weight of soap, up to 10% by weight and preferably 1 to 7% by weight of citrate and optionally enzymes, brighteners, dye, perfume, polymers (for example against redeposition) and/or phosphonates.

Besides the particles used in accordance with the invention, an aftertreatment composition, such as a fabric softener, contains cationic surfactants and optionally other typical ingredients and solvents.

### EXAMPLES

The improvement in soil removal and the reduction in resoiling was determined by measuring the change in the hydrophilicity of textile surfaces. Swatches measuring 2 cm×8 cm were stirred for 24 hours in

A water

B 2.5% SiO₂ sol (obtainable from Merck KGaA, Darmstadt, 10%)

C 2.5% SiO₂ sol (obtainable from Merck KGaA, Darmstadt, 10%)+0.1% Sokalan® HP 22 (polyethylene glycol/vinyl acetate polymer, a product of BASF AG)

D 0.1% Sokalan® HP 22 (polyethylene glycol/vinyl acetate polymer, a product of BASF AG)

The swatches were then dried and their water absorption capacity (in g) was measured using a commercially available tensiometer (Krüss K14). The textile test specimen was automatically brought towards the water surface from above until the first contact with water produced an increase in weight detectable by the instrument. The further increase in weight was then measured for two minutes with the textile stationary.

The measurement results are set out in the following Table, the increase in hydrophilicity being shown in %, based on the value of the treatment with water. The hydrophilicity of the textile after the treatment with water was taken to be 1.

| | A | B | C | D |
|---|---|---|---|---|
| Cotton | 1 | 13 | 5 | −2.6 |
| Polyester/cotton | 1 | 15 | 15 | 1.4 |

The measurement results show that the hydrophilicity of cotton and cotton/wool blends can be distinctly increased.

1. The use of particles with a particle size of 5 to 500 nm for improving soil removal from and/or reducing the resoiling of surfaces.

2. The use claimed in claim 1, characterized in that the particles have a particle size of 5 to 250 nm.

3. The use claimed in claim 1 or 2, characterized in that the particles are selected from any precipitated silicas, aerogels, xerogels, Mg(OH)₂, boehmite (Al(O)OH), ZrO₂, ZnO, CeO₂, Fe₂O₃, Fe₃O₄, TiO₂, TiN, hydroxylapatite, bentonite, hectorite, SiO₂:CeO₂, SnO₂, In₂O₃:SnO₂, MgAl₂O₄, HfO₂, sols, such as SiO₂ sols, Al₂O₃ sols or TiO₂ sols and mixtures of the above.

4. The use claimed in any of claims 1 to 3, characterized in that the surfaces are textile surfaces and/or hard surfaces.

5. The use claimed in any of claims 1 to 4, characterized in that the particles are used for finishing textiles, in laundry detergents or for the pretreatment or aftertreatment of textiles.

6. The use claimed in claim 5, characterized in that the particles are present in the compositions in a quantity of 0.01 to 35% by weight, based on the final composition.

7. The use claimed in claim 5 or 6, characterized in that the nanoscale particles are present in the in-use solution in a quantity of 0.001 to 10% by weight and preferably in a quantity of 0.01 to 2% by weight, based on the in-use solution.

8. The use claimed in any of claims 5 to 7, characterized in that the pH of the in-use solution is between 6 and 12 and more particularly between 7 and 10.5.

9. The use claimed in any of claims 1 to 8, characterized in that the particle surfaces are modified with complexing agents selected from the phosphonates, such as 1-hydroxyethane-1,1-diphosphonic acid, aminotri(methylenephosphonic acid), diethylenetriamine penta(methylenephosphonic acid) and 2-phosphonobutane-1,2,4tricarboxylic acid (PBS-AM) which are generally used in the form of their ammonium or alkali metal salts, heavy metal complexing agents, such as ethylenediamine tetraacetic acid or nitrilotriacetic acid in the form of the free acids or as alkali metal salts and derivatives thereof, alkali metal salts of anionic polyelectrolytes, such as polymaleates and polysulfonates, and low molecular weight hydroxycarboxylic acids, such as citric acid, tartaric acid, malic acid, lactic acid or gluconic acid and salts thereof.

10. The use claimed in any of claims 5 to 9, characterized in that the compositions contain hydrophilizing agents selected from the group consisting of ethanol, n- or i-propanol, butanols, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol monomethyl or monoethyl ether, diisopropylene glycol monomethyl or monoethyl ether, methoxy, ethoxy or butoxytriglycol, 1-butoxyethoxy-2propanol, 3-methyl-3-methoxybutanol, propylene glycol t-butyl ether, alcohols, more particularly C₁₋₄ alkanols, glycols and polyols and polyethylene glycol liquid at room temperature, carboxylic acid esters and mixtures of the above.

11. The use claimed in any of claims 1 to 10, characterized in that the particles are incorporated in liquid or gel-form or solid compositions, more particularly powders or compactates, such as tablets.

12. The use claimed in any of claims 1 to 11, characterized in that surfactants selected from nonionic, anionic, amphoteric and cationic surfactants and mixtures thereof are additionally used.

13. Textile treatment compositions, characterized in that they contain particles with a particle size of 5 to 500 nm for improving soil removal from and/or reducing the resoiling of textile surfaces.

14. Compositions as claimed in claim 13, characterized in that builders selected from the group consisting of zeolites, silicates, carbonates, organic builders and co-builders and phosphates are present.

15. Compositions as claimed in claim 13 or 14, characterized in that they contain enzymes, bleaching agents, bleach activators, complexing agents, redeposition inhibitors, foam inhibitors, inorganic salts, solvents, pH adjusters, perfumes, perfume carriers, fluorescers, dyes, hydrotropes, silicone oils, other soil release compounds, optical brighteners, discoloration inhibitors, shrinkage inhibitors, anti-crease agents, dye transfer inhibitors, antimicrobial agents, germicides, fungicides, antioxidants, corrosion inhibitors, antistatic agents, ironing aids, waterproofing and impregnating agents, swelling and non-slip agents, UV absorbers and mixtures thereof.
